(19) United States
(12) Patent Application Publication
(10) Pub. No.: US 2026/0352019 A1
(43) Pub. Date: Nov. 5, 2026

(54) CHARGING DEVICE FOR THE INDUCTION CHARGING OF A MOBILE TERMINAL, MOTOR VEHICLE WITH A CHARGING DEVICE OF THIS TYPE AND OPERATING METHOD FOR THE CHARGING DEVICE

(71) Applicant: AUDI AG, Ingolstadt (DE)

(72) Inventors: Holger THIEL, Wettstetten (DE); Simon WEISS, Titting (DE)

(73) Assignee: AUDI AG, Ingolstadt (DE)

(21) Appl. No.: 19/484,657

(22) PCT Filed: May 10, 2024
(86) PCT No.: PCT/EP2024/062932

§ 371 Date: Nov. 14, 2025

(30) Foreign Application Priority Data
May 17, 2023 (DE) 10 2023 113 098.6

(51) Int. Cl. H02J 50/00; H02J 7/70; H02J 50/10; H02J 50/90

(52) U.S. Cl. CPC H02J 50/005; H02J 7/731; H02J 50/10; H02J 50/90

(57) ABSTRACT

A charging device for inductive charging of a mobile terminal. The charging device has a supporting plate for placing the terminal in a supporting volume, and an electrical transmitting coil for generating an alternating magnetic field for induction charging and a magnet arrangement for a magnetic fixing of the terminal with respect to the transmitting coil by a permanent magnetic field of the magnet arrangement while the terminal is placed on the supporting plate. The transmitting coil and the magnet arrangement are arranged together in a holding device, which is arranged in a recess of the supporting plate and which by a bearing device is mounted in the recess so as to be movable along a coil axis of the transmitting coil wholly or partially out of the recess toward the supporting volume.

### CROSS-REFERENCE TO RELATED APPLICATIONS

This application is a U.S. national stage of International Application No. PCT/EP2024/062932, filed on May 10, 2024, which claims the priority benefit of German Patent Application No. 10 2023 113 098.6 filed on May 17, 2023. Both the International Application and the German Patent Application are incorporated by reference herein in their entirety.

### BACKGROUND

### 1. Field

An invention according to described examples relates to a charging device for the induction charging of a mobile terminal, for example a smartphone or a tablet PC. The charging device may for example be part of a so-called docking station, such as can be provided for example in a center console of a motor vehicle. In order to be able to put down the mobile terminal, the charging device has a supporting plate, from which an alternating magnetic field for induction charging can be generated by an electrical transmitting coil (charging coil). In order to adjust the transmitting coil in its position with respect to the terminal, a magnet arrangement is provided, such as can be provided for example according to the standard Qi2™. The invention according to the examples also includes a motor vehicle with the charging device and an operating method according to which the charging device can be operated.

### 2. Description of the Related Art

In order to be able to wirelessly recharge or supply electrical energy to a portable mobile terminal, such as a smartphone or a tablet PC, in a charging device there may be integrated an electrical transmitting coil or charging coil for induction charging. This obviates the need to attach the terminal to a charging plug. A charging device for induction charging may additionally have a magnet arrangement, for example a circular ring arrangement of magnets or at least a circular arc arrangement (partial circle) of such magnets, in order to be able to fix or predetermine a position of the terminal with respect to the transmitting coil. Known standards for this are MagSafe(™) and Qi2(™).

In the mobile terminal, the electrical receiving coil for induction charging is usually located on the rear side, i.e. the wall of the terminal facing away from the main screen. Together with the receiving coil, a corresponding magnet arrangement may also be integrated in this wall in order to be able to ensure the described magnetic fixing of the receiving coil with respect to the transmitting coil.

One problem with today's mobile terminals is that their rear side, i.e. the rear wall with the receiving coil integrated in it, is often not flat or level, but instead for example includes a camera of such a size as to have the effect that there is no level supporting surface. So if you place the terminal with its rear side on a supporting plate of a charging device, it will therefore not lie flat on the supporting plate, but will assume a tilted position for example due to the camera. Accordingly, there is an air gap between the rear wall of the terminal and the supporting plate. The alternating magnetic field must be transmitted from the transmitting coil of the charging device to the receiving coil across this air gap, resulting in a reduction in energy efficiency. In addition, the air gap makes the magnetic holding force too low to keep the phone in the desired position.

Charging devices with level charging plates are known for example from DE 11 2020 003 590 T5 and US 2020/0083726 A1. With these charging devices, the problem of a protruding camera is solved by the fact that the supporting plate is smaller than the rear wall of the terminal, so that the camera can protrude beyond the supporting plate. However, this reduces the holding of the terminal in the charging device.

KR 10 2012 0 117 262 A discloses a wireless energy transmitter for vehicles for matching a position of a first coil within a housing with the position of a second coil using a mechanical device. For this purpose, a position fixing device selectively fixes or releases a position of a transmission coil unit, which is arranged in the housing and comprises the first coil and a magnet, according to the user control. The charging energy is supplied by inductive coupling of the first coil and the second coil of a charging target device, for example a mobile terminal. Another magnet is attached to the charging target device. The transmission coil unit is therefore only movable within the housing, but a supporting plate on which the charging target device is put down for charging represents a surface of the housing. Therefore, a skewed position of the charging target device on the supporting plate, as a result of which energy transmission may be obstructed by an air gap formed between the charging target device and the supporting plate, cannot be compensated by this device.

EP 2 946 050 B1 discloses a device for the wireless transmission of electrical power and electrical signals, comprising a first electrical component attached to a mechanical structure, in particular in a housing or a trim part, wherein the first electrical component is held so as to be movable and actuating means for the relative movement of the first electrical component are provided, wherein for this purpose the actuating means are set up so as, depending on the position of a second electrical component with respect to the mechanical structure, to improve the electromagnetic coupling between the first and the second electrical component by a movement of the first electrical component, wherein at least one of the electrical components is mounted rotatably in a mounting box, with a pan mounted rotatably in the mounting box being provided for receiving the electrical components, and operating means for positioning the pan in the mounting box are provided. In other words, both components to be contacted are permanently installed, for example in a door (the first component then in the door frame and the second component in the door leaf or vice versa) and both components are arranged in the rotatably mounted pan.

US 2015/0270046 A1 discloses an electronic device comprising the following: a housing defining a connecting surface; and a magnetic element arranged adjacent to the connecting surface and within the housing, wherein the magnetic element is configured so as to align the housing with an adjacent outer surface by moving either the housing or the outer surface relative to one another in order to achieve an aligned position; and the magnetic element is also configured so as to resist separation of the housing from the outer surface when the housing and outer surface are in the aligned position. However, no air gap such as can be caused by a protruding camera can be bridged.

WO 2014/157840 A1 discloses a wireless energy transmission device and a vehicle equipped with it, wherein the wireless energy transmission device comprises: a transmitting unit for transmitting a wireless energy signal to a wireless energy receiving device; and an upward drive unit for driving the transmitting unit upward. In particular, the design provides for energy transmission to terminals of different sizes.

DE 10 2018 201 300 A1 discloses a charging device for the wireless charging of an electrical energy storage device of a mobile terminal, wherein the charging device comprises a housing with charging electronics, with a supporting area for the mobile terminal and with an air inlet opening and an air outlet opening, wherein the charging device has an air conveying device for sucking in air through the air inlet opening, to allow an air delivery path through the air delivery unit, and for blowing out the air through an air outlet opening, i.e. a cooling device for a charging device.

### SUMMARY

The invention according to the examples addresses the problem of allowing an efficient inductive charging process even in the case of a charging device with a supporting plate on which it is intended that the entire terminal can rest.

The problem is solved by the subject matter of the independent patent claims. Advantageous further developments of the invention according to the examples are described by the dependent patent claims, the description that follows and the figures.

As a solution, the invention according to the examples provides a charging device for the inductive charging of a mobile terminal (hereinafter may be referred to as a terminal). Understood here as a mobile terminal, in a known way, are a portable computer device, in particular a smartphone or a tablet PC.

In a known way, the charging device has a supporting surface or supporting plate for placing the terminal. The supporting plate may be part of a larger structure, for example a trough or a trim part in the interior of a motor vehicle. The supporting plate may be so large or dimensioned such that a terminal can be placed on it or can rest on it over its full length and/or width. Dimensions by way of example are edge lengths in a range of more than 15 cm, for example in a range of 15 cm to 25 cm. In the placed-on state, the terminal is then on the supporting plate. This spatial area above the supporting plate is referred to here as the “supporting volume”.

In a way know per se, the charging device also includes an electrical transmitting coil or charging coil, which is set up to generate an alternating magnetic field for induction charging. Of course, the corresponding power electronics for the operation of the electrical transmitting coil for generating the alternating magnetic field may also be provided in the charging device. However, for the purposes of understanding the invention according to the examples, it is sufficient to know the electrical transmitting coil.

Finally, a magnet arrangement, for example a circular ring or an arc of magnets, is also provided in the charging device. This magnet arrangement is set up to fix the terminal magnetically with respect to the transmitting coil by a permanent magnetic field of the magnet arrangement or a magnetic field of the magnet arrangement that is time-invariant at least during the induction charging. The magnet arrangement may for example be formed by permanent magnets, as known per se for the standards already mentioned. The fixing of the terminal is made possible while the terminal is on the supporting plate or has been placed on there if the terminal is in the supporting volume.

In order in the case of this arrangement to avoid that an air gap remains between the transmitting coil and the applied terminal for example due to a protruding camera of the terminal, it is provided according to the examples of the invention that the transmitting coil and the magnet arrangement are arranged together in a holding device. This holding arrangement represents a “charging head” movably mounted in the supporting plate. The holding device may for example be configured as a housing, such as can be produced for example from a plastic by an injection-molding process. The holding device is movably arranged in the supporting plate by a recess in which the holding device is arranged being provided in the supporting plate. The holding device is therefore not covered by the supporting plate, but can be in direct contact with a placed-on terminal through the recess. The holding device may for example be configured as a stub or cylinder or puck (in particular a flat cylinder, with a diameter that is at least three times greater than the cylinder height). A correspondingly round recess, in which the holding device is then arranged, can then be provided in the supporting plate.

In order to close an air gap between the placed-on terminal and the charging device, the holding device is movably arranged in the recess of the supporting plate by a mounting or bearing device, specifically the holding device can be moved at least along a coil axis of the transmitting coil fully or partially out of the recess toward the supporting volume. In other words, the coil can slide out or be moved out of the recess along its coil axis. The coil axis is a virtual line that represents a surface normal of the winding plane of the turns of the coil. The transmitting coil is in particular arranged coplanar or plane-parallel to a plane described by the surface of the supporting plate. The holding device may in this case be driven by the bearing device in a motorized manner, for example by an electric motor, and/or the bearing device may also bear or hold the holding device correspondingly loosely or with play, so that the holding device can for example be extended out of the recess by the described permanent magnetic field of the magnet arrangement and a resulting magnetic force. So if you place a terminal on the supporting plate, then, as a result of its bearing device, the holding device can be moved at least along the coil axis out of the recess toward the mobile terminal and therefore come to lie against the terminal without any gap (that is to say without an air gap in between) or lie in contact there, in particular in direct contact, while the terminal is placed or put down on the supporting plate.

The invention according to the examples provides the advantage that, even if a terminal cannot be placed in the region of its receiving coil onto a supporting plate of the charging device completely or without any gap, because for example a projecting or protruding camera of the terminal prevents placing it flat or placing it without any gap, nevertheless the transmitting coil can be moved out of the recess of the supporting plate to the terminal as a result of its movably mounted holding device, whereby an air gap can be avoided and the alternating magnetic field of the transmitting coil can therefore efficiently penetrate or pass over into the terminal and its receiving coil.

The invention according to the examples also comprises further developments which result in additional advantages.

If the camera or some other extension is located in an edge region of the rear wall of the terminal, the terminal will be tilted on the supporting plate when it is placed on, whereby the rear wall of the terminal is aligned in a skewed manner in relation to the supporting plate. In order to also compensate for this inclination angle of the rear wall of the terminal, a further development provides that the holding device is mounted so as to be tiltable with respect to the supporting plate as a result of the bearing device. For example, the bearing device can provide corresponding play or free space for tilting of the holding device in the recess. In addition or alternatively, for example, a part of the bearing device may be configured as a spherical segment. The holding device is therefore not only mounted so as to be movable transversally out of the recess along the coil axis, but may also be inclinable or tiltable. A maximum tilting angle of the coil axis which is obtained with respect to a surface normal of the plane in which the supporting plate extends may be an amount in a range of 0 degrees to 40 degrees. Therefore, the holding device can lie in direct contact over the entire surface area with that attachment surface or that attachment area by which the holding device is intended to become attached to the terminal as a result of the permanent magnetic field even when the terminal rests tilted or inclined on the supporting plate.

After removing or taking away the terminal, the holding device may automatically retract into the recess of the supporting plate. For this purpose, according to a further development it is provided that, when there is an empty supporting volume (i.e. when no terminal rests on the supporting surface), the holding device is kept in a retracted position, in which the holding device is retracted in the recess, by its bearing device in a gravity-based and/or spring-based manner. If for example the supporting surface is aligned horizontally, the holding device can fall back into the recess as a result of a correspondingly looser or loose arrangement (the bearing device is correspondingly loosely designed). In order to ensure this even for example when there are vibrations, i.e. to secure the retracted position even when there are vibrations, a retaining spring may be provided in order to keep the holding device in the retracted position. This is advantageous in particular when using the charging device in a motor vehicle, where during a journey shaking movements could otherwise cause the holding device to vibrate or rattle in the recess.

In order to move the holding device out of the recess into the supporting volume, i.e. toward the terminal, when placing on a terminal, it is provided as a particularly robust and efficient mechanism that, according to a further development, a magnetic field strength of the magnet arrangement in relation to a dead weight of the holding device and in relation to a retaining force of the bearing device is so great or great enough to pull or move the holding device out of its retracted position or out of the holding device into an extended position, in which the holding device fully or partially protrudes from the recess in the described way, and keep it there. This of course assumes that the magnet arrangement has a corresponding magnet arrangement or a magnetic arrangement (for example a soft iron sheet) in its permanent magnetic field, i.e. that the holding device becomes attached to a magnetic terminal. Therefore, the holding device can pull itself toward the terminal as a result of the permanent magnetic field of its magnet arrangement. In order to make this possible, the holding device is balanced in the way described, for example by choice of the material (for example a plastic) and/or a material thickness of the holding device and/or with respect to the retaining force of the bearing device, i.e. for example the retaining force of the described spring arrangement or retaining spring, in such a way that the magnetic field strength of the magnetic arrangement is sufficient for this.

During a charging process, an electrical energy storage device of the mobile terminal should be kept in a temperature window, which is also referred to as the “comfort zone” of the energy storage device. This is particularly important for energy storage devices based on lithium-ion batteries. In order to achieve this, a further development provides that a fan which is set up to convey an air flow through the recess, i.e. along an outer wall of the holding device and/or through the holding device, is provided in the charging device. For example, the air flow can suck in air between the placed-on terminal and the supporting plate and suck this sucked-in air through the recess past the holding device and/or through it into the interior of the charging device. Blowing toward the terminal may also be provided. In order for the air flow to be conveyed through the holding device, this may for example have corresponding through openings or ducts. Conveying an air flow in the area of the recess and the holding device provides the advantage that a heat source, specifically the transmitting coil and the area of interaction between the transmitting coil and the terminal, are actively cooled.

In order to allow cooling and air exchange between the terminal (in the placed-on state) and the supporting plate, a further development provides that the supporting plate has supporting bars or supporting ribs for the terminal. In other words, the terminal is not in contact with the supporting plate over the entire surface area of its rear wall, but rests on an effective supporting surface which is provided by the bars. In particular, the supporting surface is thereby reduced to a value less than 20 percent, in particular less than ten percent, of the total surface area of the supporting plate covered or covered over by a terminal. Therefore, air can flow between the terminal and the supporting plate, specifically flow through between the supporting bars or supporting ribs. This can be advantageous for convection cooling. In connection with the fan described, the air flow delivered by this fan can in this way be conveyed through between the terminal and the supporting bars/supporting ribs. The reduced contact surface or the supporting surface reduced to the contact surface of the supporting bars/supporting ribs also reduces heat transfer between the supporting plate and the terminal.

When removing the terminal from the supporting plate, it may be prevented that the holding device remains attached to the terminal by the transmitting coil and the magnet arrangement. For this purpose, a further development provides that the bearing device by which the holding device is mounted or held with respect to the supporting plate has a retaining device which limits an extension displacement of the holding device out of the recess to a displacement length of less than three centimeters. For example, the extension displacement may be limited to a value in the range of five millimeters to 15 millimeters. If a user picks up the terminal from the supporting plate, when the extension displacement is reached the holding device is therefore retained by the retaining device, and the user thus pulls off the terminal from the holding device. The magnet arrangement may have a permanent magnet force which allows this for example with a force of less than ten newtons, in particular less than six newtons.

In order to provide such a retaining device, a further development provides that the holding device provides a ring or multiple tabs, by which a diameter of the holding device in the region of the retaining device is greater than the recess. In other words, the ring or the multiple tabs on the holding device do not fit through the recess. Therefore, the holding device strikes with the ring or the tabs against an edge of the recess, which then means that the extension displacement is reached.

The part of the holding device protruding through the recess may be configured in the way described as a cylindrical socket or as a cylindrical head piece, i.e. in particular as a flat cylinder, the diameter of which is at least four times as great as the height or length of the socket or head piece along the coil axis. The part of the socket or head piece that is facing the terminal or the supporting area has a level base area, which represents an attachment area for magnetic attachment to the terminal. The ring or the tabs of the retaining device can then be provided in the way described on a lower region, or a region facing away from the base area, of the socket or head piece, so that the socket or the head piece cannot be pulled out of the recess.

The holding device may be fixed with respect to the supporting plate against a translational movement parallel to the plane in which the supporting plate extends. In other words, the holding device cannot be translatorily moved laterally in the supporting plate, but can only be extended out of the holding plate and may be at the same time still be tilted. For this translational fixing, a shape of the recess in the supporting plate may for example correspond to the shape or the contour of the holding device to the extent that a play in the direction of translational movement is less than three millimeters, in particular less than two millimeters. This then still allows the tilting movement, but a translational movement by more than this play is then blocked. The fixing with respect to translational movement has the advantage that the terminal cannot “wander” on the supporting plate in the placed-on state, i.e. does not slip there, as could otherwise be caused for example in a motor vehicle by vibrations when driving over an uneven driving surface.

As already explained, a further solution of the invention according the examples provides the described motor vehicle in which at least one charging device of the type described is provided. This charging device is particularly advantageous in a motor vehicle because a terminal can be put down on the supporting plate, for example in an area of a center console, and can be recharged there by induction charging.

The respective supporting plate of each charging device may be aligned in the motor vehicle in a horizontal plane or in a plane whose normal vector has an angle of less than 20 degrees to the vertical. In other words, the terminal therefore lies flat or aligned horizontally, or at least inclined by less than the described inclination, in the motor vehicle on the supporting plate. Therefore, it can also be ensured, for example when driving through a pothole, that the terminal remains attached to the holding device, which is not necessarily ensured in the case of a more or further tilted position due to the jerking forces occurring.

When the charging device is operated, this gives rise to the method also included in the invention according to the examples, which involves using a mobile terminal which has the receiving coil for induction charging and a magnetic fixing device (for example a ring of permanent magnets and/or a soft magnetic sheet) in its rear wall facing the supporting plate of the charging device. When placed on the supporting plate, this mobile terminal enters by its fixing device into a magnetic interaction with the holding device of the charging device, which indeed also has a magnet arrangement with a permanently magnetic magnetic field. By a resulting magnetic force of the interaction, the holding device is fully or partially extended out of the recess of the supporting plate and in addition the terminal is pulled into a predetermined relative position in relation to the transmitting coil of the holding device. In other words, the receiving coil and the transmitting coil “find each other” as a result of the magnetic interaction between the terminal and the holding device. The terminal can then also be put down on the supporting plate in such a fixed manner, wherein it does not matter or can be compensated if the wall cannot rest fully on the supporting plate, because for example a camera of the terminal projects or protrudes from the wall. The holding device can for example be tilted accordingly, in order nevertheless to lie with the attachment area or the attachment surface against the wall of the terminal without any gap.

The invention according to the examples also includes further developments of the method that may arise as a result of the corresponding developments of the charging device according to the examples of the invention. For this reason, the corresponding features of the further developments of the method are not described here again.

For application cases or application situations that can arise with respect to the method and are not explicitly described here, it may be provided that, according to the method, an error message and/or a request for input of a user acknowledgement is issued and/or a default setting and/or a predetermined initial state is set.

The motor vehicle according to the examples of the invention may be configured in particular as a passenger car or truck, or as a minibus or motorcycle.

The invention according to the examples also comprises the combinations of the features of the examples described. The invention according to the examples therefore also comprises implementations that each have a combination of the features of several of the examples described, unless the examples have been described as mutually exclusive.

### BRIEF DESCRIPTION OF DRAWINGS

Examples of the invention are described below. In the figures:

FIG. 1 shows a schematic representation of a motor vehicle according to an example of an invention with a charging device, a holding device of which is shown once in a retracted position and once in an extended position;

FIG. 2 shows the charging device from FIG. 1 in a side view with the holding device once in the retracted position and once in the extended position;

FIG. 3 shows a schematic representation of a process of placing a mobile terminal on the charging device, whereby an example of a described method is obtained;

FIG. 4 shows a schematic representation of a longitudinal section of the charging device with a cooling device having a fan, according an example.

### DESCRIPTION

The examples explained below are examples of the invention. In the examples, the described components of the examples each constitute individual features of the examples of the invention which are to be considered independently of one another and which each also develop the examples of the invention independently of one another. Therefore, the disclosure is intended to also comprise combinations of the features of the examples other than those described. Furthermore, the described examples can also be supplemented by further features of the examples of the invention from among those which have already been described.

In the figures, identical reference signs each denote elements of identical function.

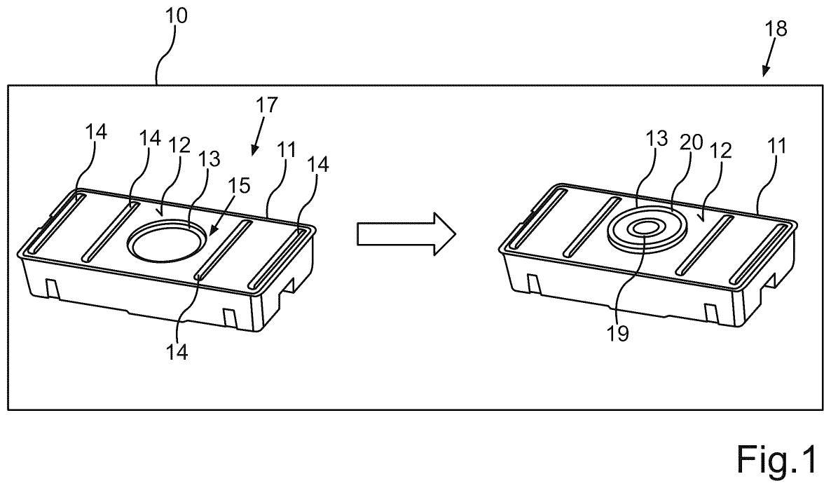

FIG. 1 shows a motor vehicle 10, which may be a motor car, in particular a passenger car, or a truck. In the motor vehicle 10, a charging device 11 may be provided, and is shown in the figure in two different states.

The charging device 11 may for example be provided in a center console or in a rear bench seat or in an interior trim of a vehicle door, to name just some examples of installation locations. The charging device 11 may have a supporting surface for a mobile terminal, which may be formed by a supporting plate 12. The supporting plate 12 may have supporting bars 14.

For inductive charging, a holding device 13 may be provided, arranged sunken in a recess 15 of the supporting plate 12. The recess 15 may for example have been created in the supporting plate 12 as a drilled hole or in an injection-molding process.

The holding device 13 may for example have been created as a flat cylinder in the way described, that is to say by a stub or as a charging head. In a retracted position 17, the holding device 13 may be sunken in the recess 15 in such a way that the holding device 13 finishes flat against or flush with the supporting plate 12. This prevents an object from being able to catch on a protruding edge of the holding device 13 and also no dirt can collect at an edge. In an extended position 18, on the other hand, the holding device 13 can be moved out of the recess. This extended position 18 is assumed by the holding device in particular when a terminal rests with a magnetic rear wall on the supporting plate 12.

In the holding device 13 there may be embedded or integrated a transmitting coil 19 for induction charging and a magnet arrangement 20, for example a ring of permanent magnets. Power electronics for the operation of the transmitting coil 19 may be provided in a way known per se. They are no longer relevant here for the explanation of the invention.

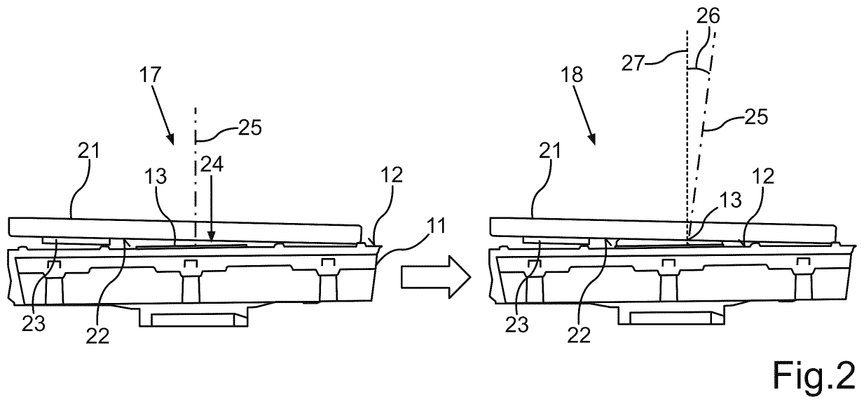

FIG. 2 shows in a side view how, when the terminal 21 is placed on, a rear wall 22 of the terminal 21 that is facing the supporting plate 12 can be aligned at a skewed angle with respect to the supporting plate 12, because for example a camera 23 of the terminal 21 protrudes from the wall 22. If the holding device 13 assumes the extended position 18, it can thus nevertheless be prevented that an air gap 24 remains between the holding device 13 and the wall 22 of the terminal 21. For changing to the extended position 18, the holding device 13 can be moved out or extended along a coil axis 25 of the transmitting coil 19 and additionally inclined or tilted by a tilting angle 26 with respect to the vertical 27.

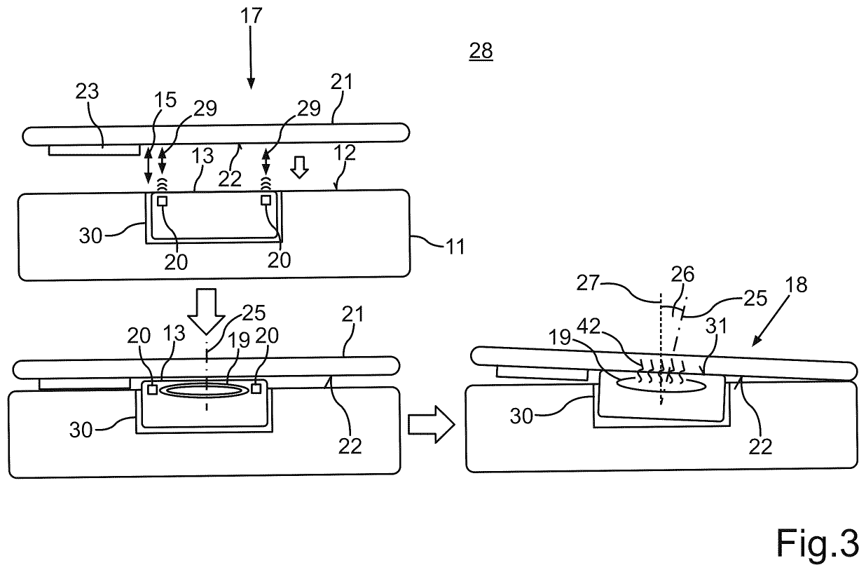

FIG. 3 illustrates this adjusting process or extending process 28, by which the holding device 13 is extended out of the recess 15 from the supporting plate 12. If the terminal 21 approaches the supporting plate 12, a magnetic fixing device in the terminal 21, for example further permanent magnets, and the magnet arrangement 20 in the holding device 13 can cause a magnetic interaction 29, as a result of which a magnetic force acts on the holding device 13. A bearing device 30 for the holding device 13 keeps it mounted as so to be translatorily movable and may also tiltable in relation to the supporting plate 12 along the coil axis 25, so that in the extended position 18 the holding device 13 has been extended or moved out of the recess 15 of the supporting plate 12 to such an extent that it lies with a contact surface 31 completely in direct contact with the wall 22 of the terminal 21. Therefore, an alternating magnetic field 42 generated by the transmitting coil 19 can pass through the receiving coil of the terminal 21 efficiently or with particularly low loss.

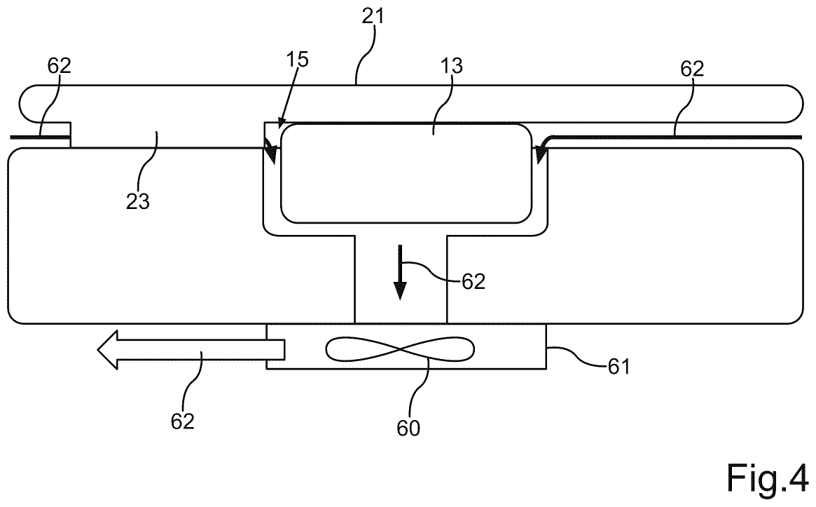

As shown in FIG. 4, during the charging process carried out after placing the mobile terminal 21 on the holding device 13, a fan 60 of a cooling device 61 may be operated, by which an air flow 62 is sucked through the recess 15 and therefore past the holding device 13 and/or through it into the charging device 11 or is expelled from it, so that the cooling air flow 62 is conveyed between the mobile terminal 21 and the supporting plate 12.

According to an example, the way in which the charging device is provided in the vehicle is as follows.

A putting-down surface which contains the electronics, the cooling system and the transmitting coils is made available in the vehicle. The surface of the supporting surface or putting-down surface may be a non-slip configuration. In order to cool the supporting surface by a fan, the supporting surface may keep a distance between the phone and the surface, for example by supporting bars or supporting ribs.

In addition, most phones have a camera that can be located almost anywhere. This leads to the problem that the coil with the magnet can be at different distances from the phone. To ensure the charging function and the positioning of the phone, the transmitting coil must lie completely in contact with the coil of the phone.

For this purpose, the transmitting coil with a surrounding magnet can move upward along the coil axis. In an example, it can in addition be laterally inclined or tilted.

Overall, the examples show how a wireless charger (charging device for induction charging) for one of the standards MagSafe and Qi2 (MPP Qi Standard) can be provided in a motor vehicle.

A description has been provided with particular reference to examples, but it will be understood that variations and modifications can be effected within the spirit and scope of the claims, which may include the phrase “at least one of A, B and C” as an alternative expression that refers to one or more of A, B or C, contrary to the holding in Superguide v. DIRECTV, 358 F3d 870, 69 USPQ2d 1865 (Fed. Cir. 2004).

1.-13. (canceled)

14. A charging device for inductive charging of a mobile terminal, comprising:
a supporting plate configured to place the mobile terminal in a supporting volume of the supporting plate;
an electrical transmitting coil configured to generate an alternating magnetic field for induction charging; and
a magnet arrangement configured to magnetically fix the mobile terminal with respect to the electrical transmitting coil by a permanent magnetic field of the magnet arrangement and a corresponding magnet arrangement for the mobile terminal while the mobile terminal is placed on the supporting plate,
wherein the electrical transmitting coil and the magnet arrangement are arranged together in form of a holding device arranged in a recess of the supporting plate and mounted in the recess by a bearing device so as to be movable along a coil axis of the electrical transmitting coil wholly or partially out of the recess towards the supporting volume.

15. The charging device as claimed in claim 14, wherein the bearing device is tiltable such that holding device is mounted to be tiltable with respect to the supporting plate as a result of the bearing device being tiltable.

16. The charging device as claimed in claim 14, wherein, when the supporting volume is empty, the holding device is in a retracted position, in which the holding device is retracted in the recess by the bearing device in a gravity-based and/or spring-based manner.

17. The charging device as claimed in claim 14, wherein a magnetic field strength of the magnet arrangement of the charging device in relation to a dead weight of the holding device and in relation to a retaining force of the bearing device is large enough to keep the holding device in an extended position, in which the holding device is protrudable from the recess, when the magnet arrangement of the holding device becomes attached to the corresponding magnet arrangement for the mobile terminal.

18. The charging device as claimed in claim 14, wherein a fan which is set up to convey an air flow through the recess along an outer wall of the holding device and/or through the holding device is provided in the charging device.

19. The charging device as claimed in claim 14, wherein the supporting plate has supporting bars for the mobile terminal.

20. The charging device as claimed in claim 14, wherein the bearing device has a retaining device which limits an extension displacement of the holding device to protrude out of the recess to a displacement length of less than 3 centimeters.

21. The charging device as claimed in claim 20, wherein the retaining device provides a ring or multiple tabs on the holding device, by which a diameter of the holding device in a region of the retaining device is greater than the recess.

22. The charging device as claimed in claim 14, wherein the holding device is a cylindrical socket or a cylindrical head piece with a level base area as an attachment area for a magnetic fixing to the corresponding magnet arrangement for the mobile terminal.

23. The charging device as claimed in claim 14, wherein the holding device is fixed against a translational movement parallel to a plane in which the supporting plate extends.

24. A motor vehicle, comprising:
a charging device for inductive charging of a mobile terminal, the charging device including,
a supporting plate configured to place the mobile terminal in a supporting volume of the supporting plate;
an electrical transmitting coil configured to generate an alternating magnetic field for induction charging; and
a magnet arrangement configured to magnetically fix the mobile terminal with respect to the electrical transmitting coil by a permanent magnetic field of the magnet arrangement and a corresponding magnet arrangement for the mobile terminal while the mobile terminal is placed on the supporting plate,
wherein the electrical transmitting coil and the magnet arrangement are arranged together in form of a holding device arranged in a recess of the supporting plate and mounted in the recess by a bearing device so as to be movable along a coil axis of the electrical transmitting coil wholly or partially out of the recess towards the supporting volume.

25. The motor vehicle as claimed in claim 24, wherein the bearing device is tiltable such that holding device is mounted to be tiltable with respect to the supporting plate as a result of the bearing device being tiltable.

26. The motor vehicle as claimed in claim 24, wherein, when the supporting volume is empty, the holding device is in a retracted position, in which the holding device is retracted in the recess by the bearing device in a gravity-based and/or spring-based manner.

27. The motor vehicle as claimed in claim 24, wherein a magnetic field strength of the magnet arrangement of the charging device in relation to a dead weight of the holding device and in relation to a retaining force of the bearing device is large enough to keep the holding device in an extended position, in which the holding device is protrudable from the recess, when the magnet arrangement of the holding device becomes attached to the corresponding magnet arrangement for the mobile terminal.

28. The motor vehicle as claimed in claim 24, wherein a fan which is set up to convey an air flow through the recess along an outer wall of the holding device and/or through the holding device is provided in the charging device.

29. The motor vehicle as claimed in claim 24, wherein the supporting plate has supporting bars for the mobile terminal.

30. The motor vehicle as claimed in claim 24, wherein the bearing device has a retaining device which limits an extension displacement of the holding device to protrude out of the recess to a displacement length of less than 3 centimeters.

31. The motor vehicle as claimed in claim 24, wherein the holding device is a cylindrical socket or a cylindrical head piece with a level base area as an attachment area for a magnetic fixing to the corresponding magnet arrangement for the mobile terminal.

32. The motor vehicle as claimed in claim 24, wherein the charging device is among a plurality of charging devices with respective supporting plates and a respective supporting plate among the respective supporting plates is arranged in a horizontal plane or in a plane whose normal vector has an angle of less than 20 degrees to a vertical plane.

33. A method of operating a charging device in a motor vehicle, comprising:
causing a magnetic interaction between a mobile terminal, which has a receiving coil for induction charging and a magnetic fixing device in a wall of the mobile terminal, and the charging device configured with a supporting plate with a magnetic arrangement and an electrical transmitting coil arranged together in form of a holding device mounted in a recess of the supporting plate, when the mobile terminal is placed on the supporting plate of the charging device, such that a magnetic force of the magnetic interaction causes the holding device to fully or partially extend from the recess of the supporting plate and to pull the mobile terminal into a relative position in relation to the electrical transmitting coil of the holding device.
